(19) United States
(12) Patent Application Publication
(10) Pub. No.: US 2010/0151832 A1
(43) Pub. Date: Jun. 17, 2010

(54) TELEPHONE ADVERTISING

(76) Inventor: Adrian Paul Romer, Northcliff (ZA)

Correspondence Address: Fitch, Even, Tabin & Flannery, Suite 1600, 120 South LaSalle Street, Chicago, IL, 60603, US

(21) Appl. No.: 12/336,198

(22) Filed: Dec. 16, 2008

(51) Int. Cl. H04M 3/00; H04W 4/00

(52) U.S. Cl. 455/412.2; 455/466

(57) ABSTRACT

An advertising message is supplied to a user of a mobile telephone device by adding an advertising message to an alerting message to provide a combined message and transmitting the combined message, as an SMS or MMS message to the mobile telephone device via a mobile telephone network. The alerting message is a notification from a financial institution. The advertising message to be sent may be selected in accordance with a business relationship with the financial institution, the time and the location of the person. The advertising message may incorporate, as embedded links, a telephone number, URL and map of the entity advertising.

### TECHNICAL FIELD

This invention relates to a system and a method for supplying advertising messages to telephone users, in particular mobile telephone users.

### SUMMARY OF THE INVENTION

According to the invention there is provided a system for supplying an advertising message to a user of a telephone device, the system including:

an advertising message adding unit for adding an advertising message to an alerting message to be sent to the telephone device, to provide a combined message; and

a transmitting unit for transmitting the combined message to a telephone network for onward transmission to the telephone device.

Further according to the invention there is provided a method of supplying an advertising message to a user of a telephone device, the method including

adding an advertising message to a text message to be sent to a telephone device to provide a combined message; and

transmitting the combined message to a telephone network for onward transmission to the telephone device.

As indicated above the telephone device may be a mobile telephone device, the telephone network then being a mobile telephone network.

It will be appreciated that the alerting message and the advertising message, and the combined message, may be a text message (such as of the Short Message Service (SMS) type) or a combination of text and pictures and sounds (such as of the Multimedia Messaging Service (MMS) type).

In particular, the alerting message may be a notification from a financial institution and the advertising message may be for a rewards partner of the financial institution.

The method may include detecting that an alerting message is to be sent and the system may include an alerting message detector for detecting that an alerting message is to be sent.

Importantly the invention may include determining the location of the telephone device and selecting an advertising message appropriate to the location. Thus the system of the invention may include a location determining module for determining the location of the telephone device and a selector for selecting an advertising message in accordance with the location.

The selector may also select advertising messages in accordance with business relationship, time and pricing model criteria.

The advertising messages may have an embedded telephone number and\or URL The advertising message may also be of a suitable size such that the text message together with the advertising message is less than the relevant prescribed maximum length. The advertising message may also incorporate a coupon or a map, which is provided via an embedded link.

The invention may include rating advertising messages by price and supplying the messages selectively in accordance therewith, the more expensive messages having priority. Similarly, telephone network operators may also be rated, with prioritised advertising messages being supplied selectively to a preferred network operator. Thus, the telephone operator that pays the most to a supplier of the service may be provided with the highest priced advertisements first.

Revenue received from advertisers may be shared in a predetermined manner with a telephone network operator.

### BRIEF DESCRIPTION OF THE DRAWINGS

The invention will now be described by way of a non-limiting illustrative example with reference to the accompanying drawings, in which:-

FIG. 1 is a block diagram showing a system in accordance with the invention, and

FIG. 2 is a flow diagram illustrating the method of the invention.

### DETAILED DESCRIPTION OF THE PREFERRED EMBODIMENT

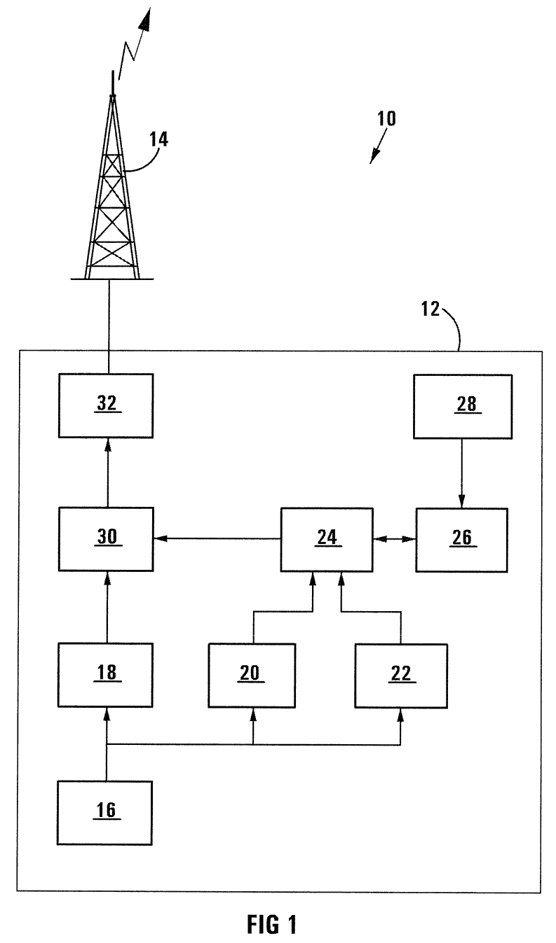

In FIG. 1, an arrangement for supplying an advertising message to a user of a mobile telephone device, is designated generally by reference numeral 10. The arrangement 10 comprises a system 12 for supplying the advertising message, in accordance with the invention and a network of cell stations 14, only one of which is shown for illustrative purposes. In this specific example, the system 12 forms part of an administrative centre of a financial institution.

The system 12 has an alerting message detector 16, an alerting message generator 18, a time monitor 20, a location determining module 22, an advertising message selector 24, an advertising message store 26, an advertising message ranking engine 28, an advertising message adder 30 to combine the alerting message and the advertising message and a transmitter 32 for transmitting the combined message being the alerting message with the selected advertising message added thereto, to the appropriate station 14, in accordance with the location of the mobile telephone device to which the combined message is being sent.

In operation, if an alerting message is to be sent to a particular client, this is detected by the alerting message detector 16 and an alerting message is generated by the alerting message generator 18. A suitable signal is also supplied by the alerting message detector 16 to the time monitor 20 and the location determining module 22. It will be appreciated that the location determining module 22 determines the location of the mobile telephone device to which the alerting message is to be sent, which is incorporated in routing information for the alerting message. The time and location are then supplied to the advertising message selector 24 which selects an advertising message from those that are stored in the store 26, and which is appropriate for that location and at that time. The advertising messages in the store 26 are prioritised in accordance with ranking criteria by the message ranking engine 28. The ranking criteria include whether the advertiser is a rewards partner of the financial institution and may be price based.

The particular advertising message selected by the advertising message selector 24 is supplied to the advertising message adder 30 which adds the selected advertising message to the alerting message (which will normally be a text message) supplied by the alerting message generator 18 and the combined message supplied to the transmitter 32 to be transmitted to the particular cell station 14, from whence it is broadcast to the relevant mobile telephone device.

An example of a combined message is:

“Payment to MACY'S for $150.00 REF#123456 cleared Nov. 22, 2008. GO RED. Get 10% off. Head to Target, get started on savings. Apply for a REDcard today. Call (212) 678 5547 now to order. www.Macys.com. Your coupon number for the discount is 12345”. DIRECTIONS”

It will be seen that the advertising message contains an embedded telephone number and a URL, such that, in conventional manner, the recipient of the advertising message may easily phone the person advertising or access its website. It also has an embedded map which is provided via the “DIRECTIONS' embedded link.

The system 12 may also have an accounting module to keep a record of which advertising messages have been used, when, to whom they were sent, the cost thereof and the manner in which the proceeds are to be shared.

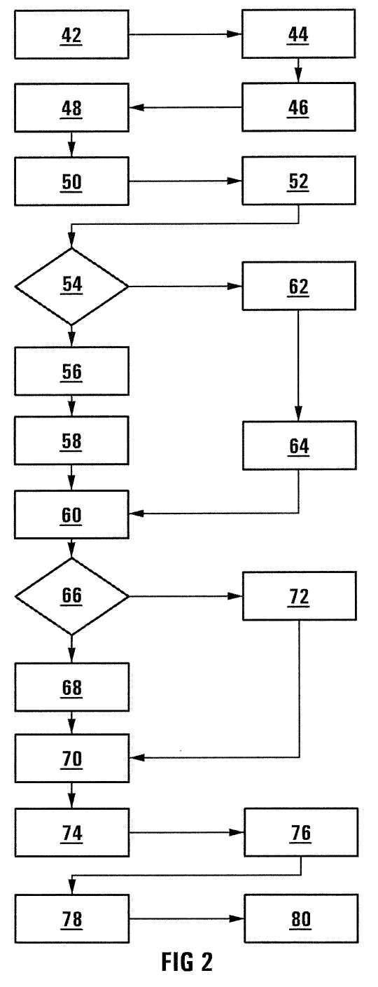

Referring to FIG. 2 a flow chart illustrating the methodology of the invention is designated generally by reference numeral 40. The occurrence of an alerting message is detected (at block 42) and the relevant alerting message generated (at block 44). The historical spending pattern of the client is determined (at block 46), the client's available current budget determined (at block 48), the date and time that the alerting message is to be sent is determined (at block 50) and the current location of the client is also determined (at block 52). A check is then conducted (at block 54) to ascertain if advertising messages from reward partners of the financial institution are available. If such advertising messages are available (at block 56), then a list of the qualifying advertising messages from reward partners is prepared (at block 58). The list of qualifying advertising messages is then ranked (at block 60) in accordance with the price that the various advertisers are prepared to pay. This is effected on an auction basis. If advertising messages from reward partners are not available (at block 62) then a list of advertising messages from other advertisers is prepared (at block 64) and then these are ranked (at block 60). The type of combined message to be sent, ie a pure text message or a text message with an audiovisual component, is then determined (at block 66). If a multimedia message is to be sent then the alerting message is provided in a multimedia format (at block 68) and the advertising message added thereto (at block 70). If a pure text message is to be sent then the alerting message is provided in a text format (at block 72) and the advertising message added thereto c. The combined message is then transmitted If a multimedia message is to be sent then the alerting message is provided in a multimedia format (at block 68) and the advertising message added thereto (at block 74) to the client. A confirmation of receipt of the combined message is detected (at block 76) and the relevant advertiser charged (at block 78). The MIS is then updated (at block 80).

1. A system for supplying an advertising message to a user of a telephone device, the system comprising:
an advertisement adding unit for adding an advertising message to an alerting message to be sent to the telephone device, to provide a combined message; and
a transmitting unit for transmitting the combined message to a telephone network for onward transmission to the telephone device.

2. The system as claimed in claim 1, wherein the telephone device is a mobile telephone device and the telephone network is a mobile telephone network.

3. The system as claimed in claim 1, wherein the alerting message and the advertising message are text messages and the combined message is of the Short Message Service (SMS) type.

4. The system as claimed in claim 1, wherein the alerting message is a text message and the advertising message is an audiovisual message and the combined message is of the Multimedia Messaging Service (MMS) type.

5. The system as claimed in claim 1, wherein the alerting message is an alerting message from a financial institution.

6. The system as claimed in claim 1, comprising an alerting message detector for detecting that an alerting message is to be sent.

7. The system as claimed in claim 1, comprising a location determining module for determining location of the telephone device, and a selector for selecting an advertising message in accordance with the location.

8. The system as claimed in claim 7, wherein the selector also selects advertising messages in accordance with business relationship, time, pricing and revenue sharing criteria.

9. The system as claimed in claim 1, wherein the advertising message includes an embedded telephone number.

10. The system as claimed in claim 1, wherein the advertising message includes an embedded URL.

11. The system as claimed in claim 4, wherein the advertising message includes a map.

12. The system as claimed in claim 11, wherein the advertising message includes an embedded link in the advertising message, which, when activated, provides a map.

13. A method of supplying an advertising message to a user of a telephone device, the method comprising:
adding an advertising message to an alerting message to be sent to the telephone device, to provide a combined message; and
transmitting the combined message to a telephone network for onward transmission to the telephone device.

14. The method as claimed in claim 13, wherein the alerting message and the advertising message are text messages and the combined message is of the Short Message Service (SMS) type.

15. The method as claimed in claim 13, wherein the alerting message is a text message and the advertising message is an audiovisual message and the combined message is of the Multimedia Messaging Service (MMS) type.

16. The method as claimed in claim 13, wherein the alerting message is a notification from a financial institution.

17. The method as claimed in claim 13, comprising detecting that an alerting message is to be sent.

18. The method as claimed in claim 13, comprising determining location of the telephone device and selecting an advertising message appropriate to the location.

19. The method as claimed in claim 13, comprising selecting advertising messages in accordance with business relationship, time, price and revenue sharing criteria.

20. The method as claimed in claim 13, wherein the advertising message includes an embedded telephone number.

21. The method as claimed in claim 13, wherein the advertising message includes an embedded URL.

22. The method as claimed in claim 15, wherein the advertising message includes a map.

23. The method as claimed in claim 22, comprising inserting an embedded link in the advertising message, which, when activated, provides a map.

24. The method as claimed in claim 13, wherein the telephone device is a mobile telephone device and the telephone network is a mobile telephone network.
